(19) United States
(12) Patent Application Publication
(10) Pub. No.: US 2003/0076677 A1
(43) Pub. Date: Apr. 24, 2003

(54) Lamp

(76) Inventors: Ferenc Mohacsi, Muskego, WI (US); Robert D. Mathson, Pewaukee, WI (US); Harry M. Pyne, New Berlin, WI (US)

Correspondence Address: Casimir F. Laska, Michael Best & Friedrich LLP, 100 East Wisconsin Avenue, Milwaukee, WI, 53202-4108, US

(21) Appl. No.: 10/274,571

(22) Filed: Oct. 21, 2002

Related U.S. Application Data
(60) Provisional application No. 60/335,947, filed on Oct. 23, 2001.

(51) Int. Cl. H01R 33/00

(52) U.S. Cl. 362/226; 362/265

(57) ABSTRACT

A light fixture including a lamp and a replaceable light cartridge that is removably interconnected to the lamp. The lamp includes a base, an arm extending outwardly from the base, and a lamp housing coupled to the arm at the end of the arm opposite the base. The replaceable cartridge is connected to the lamp housing, and comprises a bulb and a bulb housing. The bulb is a fluorescent tube that is the light source for the light fixture. A ballast that is separate and independent from the bulb, and steps up the low voltage from a power source to the high voltage current required by the bulb. The ballast is disposed within the base and is interconnected to the replaceable cartridge with a quick disconnect plug. The separate ballast and bulb allow the bulb to be replaced independently of the ballast.

This application claims priority to co-pending U.S. Provisional Patent Application Serial No. 60/335,947 filed Oct. 23, 2001.

### FIELD OF THE INVENTION

This application relates to light sources, and more particularly to fluorescent light sources.

### BACKGROUND OF THE INVENTION

Fluorescent light sources or bulbs generally require an electrical current having a relatively high voltage of 300 Volts (V) or greater to operate. The voltage of the electrical current from most conventional power sources is less than 300 V. The standard electrical line current in most buildings is between 110 to 240 Volts. Other power sources, such as batteries, may provide an electric current having a substantially lower voltage, such as 12 or 24 V.

In order to operate a fluorescent or other high intensity discharge (HID) light source from a power source producing an electrical current having a voltage substantially below 300 V, the voltage must be stepped up to an acceptable level. Fluorescent light sources generally have a ballast, or power supply, to increase the voltage of an electric current from a relatively low-voltage power source to a high-voltage level that can operate the fluorescent light source. The ballast is often combined with the fluorescent light source into a single integrated unit.

The expected life-span of a ballast is usually substantially longer than the expected life-span of a hot cathode fluorescent light source. However, with a combined ballast and fluorescent light source unit, the entire unit often must be replaced after the light source burns out. The ballast is integrated into the combined ballast and fluorescent light source unit, so a new ballast and fluorescent light source must be provided when the light source bums out. Since the ballast generally lasts longer than the fluorescent light source, a new ballast must be provided whenever the light source expires, even though the ballast may still be functional.

### SUMMARY OF THE INVENTION

The invention comprises a light fixture having a fluorescent light source for use with a relatively low-voltage power source. The light fixture comprises a lamp and a replaceable cartridge that is removably interconnected to the lamp. The lamp includes a base that may be mounted to a surface to position the light fixture in a desired location. An arm extends outwardly from the base, and a lamp housing is coupled to the arm at the end of the arm opposite the base. The replaceable cartridge is disposed within the lamp housing.

The replaceable cartridge comprises a bulb and a bulb housing. The bulb is preferably a fluorescent tube that is the light source for the light fixture, although other high intensity discharge tubes could be used. The bulb has several turns and twists to reduce the size of the bulb and increase the amount of light emitted by the bulb. The bulb housing surrounds the bulb and is preferably bell-shaped with an open output end. The bulb housing has an interior surface or coating that diffusively reflects the light emitted from the bulb toward the open end.

As described above, a fluorescent bulb generally requires an electrical current having a voltage of at least 300 Volts (V). The light fixture may be used with an electric current having a relatively low voltage power source. An example of a low voltage power source is a 12 V or 24 V battery commonly used on boats, or other similar marine vessels. The light fixture has a ballast that steps up the low voltage (12 V or 24 V) from the power source to the high voltage current (300 V) required by the bulb.

The ballast is separate and independent from the bulb. The ballast is disposed within the base and is interconnected to the power source through wires. The wires extend through the arm and into the lamp housing, and are interconnected to the replaceable cartridge with a quick disconnect plug. The quick disconnect plug permits the replaceable cartridge to be easily removed from the lamp housing and disconnected from the wires leading to the ballast. A new replaceable cartridge may also be easily reconnected to the wires leading to the ballast with the quick disconnect plug.

The separate ballast and bulb allow the bulb to be replaced independently of the ballast. As described above, the expected life-span of the ballast is significantly longer than the life-span of a hot cathode fluorescent bulb, and the bulb typically is replaced more frequently than the ballast. Since the ballast and bulb are separate, a single ballast may be used over the life-spans of multiple bulbs. Although a longer life cold cathode bulb could be used, the cost of the light fixture would also be increased.

These and other features of the present invention will be apparent to those skilled in the art from the detailed description of the invention and the drawings.

### BRIEF DESCRIPTION OF THE DRAWINGS

FIG. 1 is a cross-sectional view of a light fixture.

FIG. 2 is a cross-sectional view of the light fixture of FIG. 1.

FIG. 3 is a cross-sectional view taken along line A-A of the light fixture of FIG. 1.

FIG. 4 is a cross-sectional view of the light fixture of FIG. 1.

FIG. 5 is an exploded view of the light fixture and cartridge of FIG. 1.

FIG. 6 is a cross-sectional view of an alternate embodiment of a light fixture.

FIG. 7 is a cross-sectional view of the light fixture of FIG. 6.

FIG. 8 is a cross-sectional view of the light fixture of FIG. 6.

### DETAILED DESCRIPTION

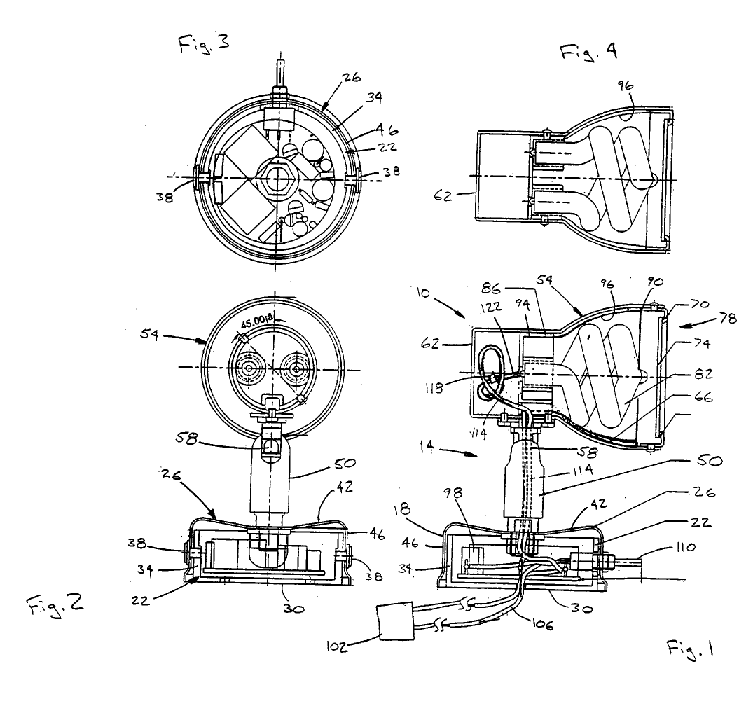

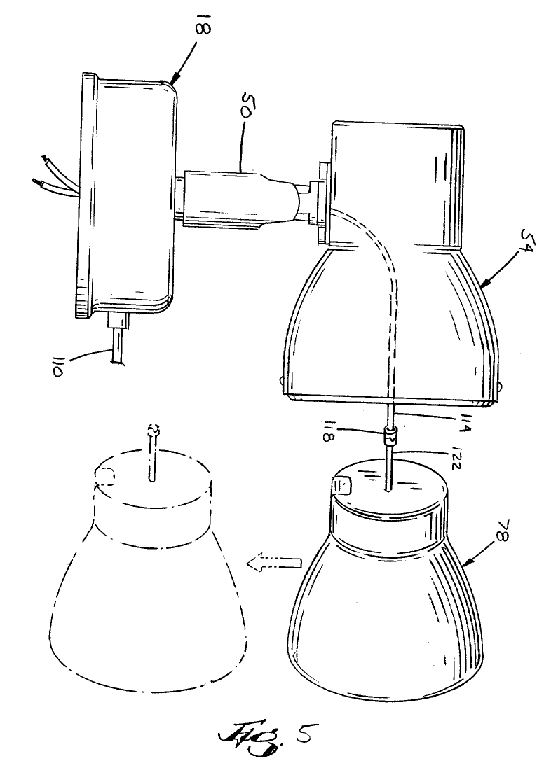

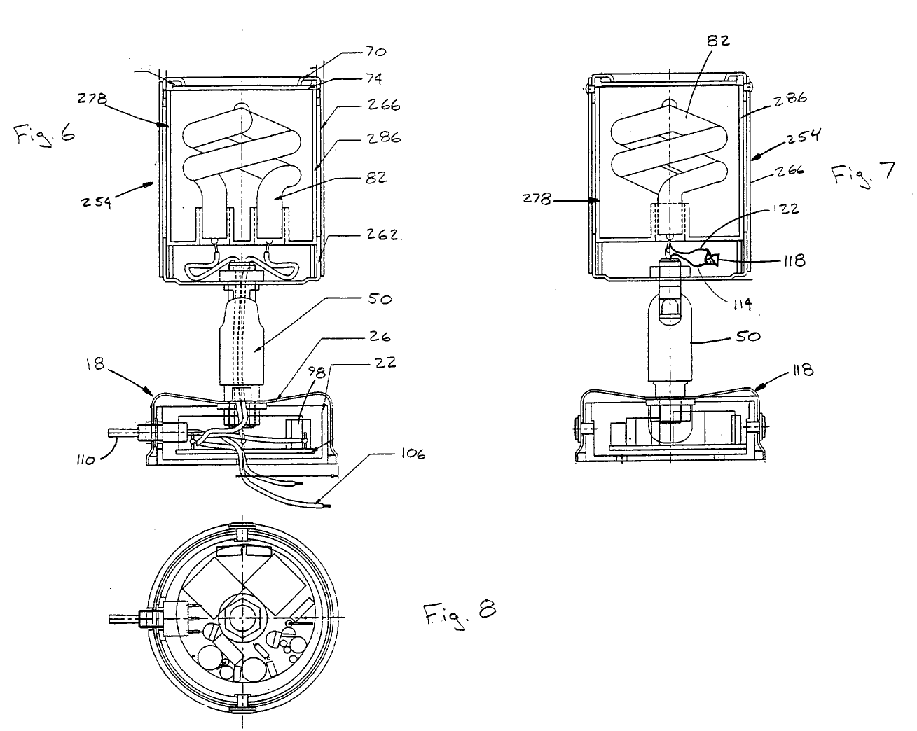

FIG. 1 illustrates a light fixture 10 having a lamp 14 that mounts to a surface to position the lamp 14 in a desired location. The lamp 14 has a base 18 that is mounted to a surface, such as a wall, ceiling, or similar surface. The base 18 includes a mount case 22 and a cover 26. The mount case 22 has a back plate 30 that generally contacts the surface the lamp 14 is mounted against, and is hidden from view when the lamp 14 is mounted. The mount case 22 also has an internal wall 34 that extends outwardly from the perimeter of the back plate 30 along the sides of the mount case 22. In the illustrated embodiment, the back plate 30 has a circular shape, and the internal wall 34 has a cylindrical ring shape, but other shapes may also be used.

The cover 26 is placed over the mount case 22 and encloses the mount case 22. The cover 26 interconnects to the mount case 22, and fasteners 38 may be used to secure the cover 26 to the mount case 22. The fasteners 38 may be any conventional fasteners, such as rivets, screws or bolts. The cover 26 has a face 42 having a shape similar to the back plate 30, and is disposed at the end of the base 18 opposite the back plate 30. The cover 26 has an external wall 46 that extends from the perimeter of the face 42 toward the back plate 30 along the sides of the cover 26. The external wall 46 is disposed radially outward from the internal wall 34, and surrounds the internal wall 34. The external wall 46 preferably contours the internal wall 34, and is shaped similarly to the internal wall 34.

As described above, the cover 26 surrounds the mount case 22 when the base 18 is assembled. The mount case 22 may be made from a relatively rigid material and is hidden from view. The cover 26 may be made from a rigid material and may have a decorative external finish, such as a metallic or other aesthetically pleasing finish. A brass or other rust resistant finish is particularly desirable for marine applications.

An arm 50 is interconnected to the base 18, and extends outwardly from the base 18. A lamp housing 54 is interconnected to the end of the arm 50 opposite the base 18. The arm 50 may have a swivel joint 58 that permits the position of the lamp housing 54 to be adjusted in relation to the base 18. The swivel joint 58 may be a ball and socket joint, or any similar pivotable joint that permits the orientation of the housing 54 to be adjusted.

The lamp housing 54 has an end cap 62 that is interconnected to the arm 50. An outer case 66 extends from the end cap 62 in a generally axial direction. In FIG. 1, the lamp housing 54 and outer case 66 are generally bell-shaped and have a curved profile. The diameter of the lamp housing 54 is smaller near the end cap 62 than at the end of the lamp housing 54 opposite the end cap 62.

As shown in FIG. 1, the lamp housing 54 may have a front cap 70 interconnected to the outer case 66 at the end of the lamp housing 54 opposite the end cap 62. The front cap 70 is generally ring shaped and retains a lens 74. The lens 74 is made from a transparent or translucent material that permits light to pass through the lens 74. In the illustrated embodiment, the lens 74 is a collimating lens. Alternatively, the lens 74 may be frosted, or may be made from a diffusive material that diffuses light as it passes through the lens 74.

The light fixture 10 has a replaceable cartridge 78 disposed within the lamp housing 54. The replaceable cartridge 78 is removably interconnected to the lamp housing 54. The replaceable cartridge 78 is a single unit that comprises a bulb 82 and bulb housing 86. The bulb 82 is a twisted fluorescent tube having several turns to reduce the amount of space occupied by the bulb 82. The twisted configuration of the bulb 82 increases the amount of light emitted from the bulb 82 while reducing the size of the bulb 82.

In the illustrated embodiment, the bulb 82 is a hot cathode tube. The hot cathode tube has a life-span of approximately 1,000 hours of use, and produces less heat than other conventional light sources, such as incandescent bulbs or halogen lights. Alternatively, the bulb 82 could be a cold cathode tube. Cold cathode tubes generally last longer than hot cathode tubes, but are also more expensive than hot cathode tubes. Cold cathode fluorescent tubes generally require at least a 800 V, 10 mA current to operate.

The bulb housing 86 is disposed within the lamp housing 54, and has a shape substantially the same as the lamp housing 54. The shape of the bulb housing 86 generally contours the shape of the lamp housing 54. As shown in FIG. 1, the bulb housing 86 may have a bell-shape, or curved profile. The bulb housing 86 has an open output end 90 and a closed end 94 disposed at opposite ends of the bulb housing 86. As shown in FIG. 1, the open output end 90 is near the front cap 70, and the closed end 94 is near the end cap 62.

The bulb 82 is connected to the bulb housing 86 near the closed end 94, and the bulb housing 86 substantially surrounds the bulb 82. The interior surface 96 of the bulb housing 86 is a diffusive reflector and reflects light emitted from the bulb 82. The bulb housing 86 may be made from a reflective material. Alternatively, the interior surface 96 of the bulb housing 86 could be coated with a reflective material, or an additional layer of a reflective material may be placed within the bulb housing 86. The bulb 82 emits light in all directions from the tube, so the bulb 82 is preferably spaced from the bulb housing 86 to permit the light emitted toward the closed end 94 to be reflected by the bulb housing 86 toward the open output end 90. The bell shape of the bulb housing 86 helps reflect light toward the open output end 90.

The bulb 82 is a hot cathode fluorescent tube, which generally requires an electric current having a voltage of about 300 Volts(V). The light fixture 10 is intended for use in applications having a relatively low voltage power source. An example of such a low voltage power source application includes use on boats, marine vehicles, or other similar applications where 12 or 24 Volt DC is used. Boats generally have a 12 or 24 V DC power source provided by batteries or a small generator. Alternatively, the light fixture 10 could be used in applications such as an automobile, recreational vehicle, mobile home, or other similar applications having a relatively low voltage power source.

A hot cathode fluorescent bulb generally requires a 300 V, 100 mA current. The light fixture 10 has a ballast 98 that converts the 12 V DC input from a power source 102 into a switched 300 V current output that can power the bulb 82. As shown in FIG. 1, the ballast 98 is disposed within the base 18 and is separate from the bulb 82. The ballast 98 is preferably also a high frequency inverter ballast that provides an output current of about 20,000 Hz or higher outside the audible range. A suitable ballast is available from Endicott Research, Inc. of Endicott, N.Y., or from Osram/Sylvania of Westfield, Ind. The ballast 98 preferably has an input of 12 VDC at 0.7 A or 24 VDC at 0.35 A, and an output of 160 Vrms at 120 mA (14 V input), 600 Vrms open circuit. The unit shuts down for Vin greater than 16 V.

As shown in FIG. 1, wires 106 enter the base 18 through the back plate 30. The wires 106 are conventional wiring, and carry an electric current from the power source 102. As shown in FIG. 1, a switch extends radially outward from the base 18. The switch turns the light fixture 10 on and off. The switch may be a conventional electric switch, such as a push-button, toggle, or rotary switch. The wires 106 connect to the switch and the ballast 98 within the base 18.

From the base 18, additional wires 114 extends through the arm 50 and into the lamp housing 54 near the end cap 62. As shown in FIG. 1, the wires 114 are interconnected to the replaceable cartridge 78 through a quick disconnect plug 118. Wires 122 extend from the quick disconnect plug 118 to the replaceable cartridge 78 and bulb 82. The quick disconnect plug 118 may be a conventional plug or clip that permits the wires 118, 122 to be removably connected.

As shown in FIG. 5, the quick disconnect plug 118 permits the wires 122 from the replaceable cartridge 78 to be easily disconnected, or reconnected, with the wires 114 leading to the base 18. Therefore, the replaceable cartridge 78 may be easily removed from the lamp housing 54 after the bulb 82 (FIG. 1) has burned out or expired. A new replaceable cartridge 78 with a fresh bulb 82 (FIG. 1) may then be easily placed into the lamp housing 54. The wires 114, 122 are preferably long enough to remove the cartridge 78 from the lamp housing 54 and access the plug 118. Once the cartridge 78 is removed from the lamp 14, the plug 118 is accessible and the cartridge 78 may be easily disconnected or reconnected to the plug 118.

As illustrated in FIG. 1, the bulb 82 or light source is separate and removable from the ballast 98 or power supply. As mentioned above, the hot cathode fluorescent bulb 82 has a useful life of approximately 1,000 hours. The ballast 98 generally lasts significantly longer than the bulb 82. In order to use a fluorescent light bulb with a low voltage power source, such as below 300 V, a ballast must be used to convert the current to the required voltage. Several existing fluorescent bulbs combine the ballast and the bulb as a single unit. With the combined bulb and ballast, the entire unit must be replaced when the bulb expires, even though the ballast may still be useful. The additional expense of providing a ballast combined with each bulb increases the cost of replacing the combined bulb and ballast unit.

In the illustrated embodiment, the bulb 82 and ballast 98 are separate, and are removably interconnected with the quick disconnect plug 118. The bulb 82 is part of the replaceable cartridge 78, and the ballast 98 is disposed within the base 18. Therefore, the same ballast 98 may be used with multiple replacement bulbs 82. The cost of replaceable cartridges 78 may be reduced in comparison to combined bulb and ballast units because the replaceable cartridge 78 does not include the ballast 98.

FIGS. 6-8 illustrate an alternate embodiment of a light fixture 210 in which a lamp housing 254 and a bulb housing 286 have a cylindrical shape, instead of the bell-shape shown in FIG. 1. In FIG. 6, an outer case 266 and lamp housing 254 are cylindrical, and the outer case 266 extends outwardly from an end cap 262. A replaceable cartridge 278 is disposed within the lamp housing 254. The replaceable cartridge 278 includes the bulb housing 286 surrounding a bulb 82. The bulb housing 286 is also cylindrically shaped and contours the shape of the lamp housing 254.

The remaining elements of the alternate embodiment illustrated in FIGS. 6-8 are similar to the elements of the previously described embodiment. In FIG. 6, an arm 50 extends between the lamp housing 254 and a base 18. A ballast 98 is disposed within the base 18. In FIG. 7, the wires 114 (only one of which is shown) from the base 18 is interconnected to the wires 122 from the replaceable cartridge 278 with a quick disconnect plug 118. As described above, the quick disconnect plug 118 permits the replaceable cartridge 278 to be easily removed from the lamp housing 254, and replaced by a new replaceable cartridge 278.

While several embodiments of the invention have been shown and described, alternate embodiments will be apparent to those skilled in the art and are within the intended scope of the present invention.

1. A light fixture comprising:
a base;
an elongated arm interconnected to the base and extending outwardly from the base;
a lamp housing connected to an end of the arm opposite the base;
a bulb interconnected to the housing;
a ballast disposed in the base and receiving an input electrical current from a power source and providing an output current to the bulb; and
a quick disconnect connector electrically connecting the ballast and the bulb.

2. The light fixture of claim 1, wherein the bulb includes a high intensity discharge light.

3. The light fixture of claim 1, wherein the lamp housing has a closed end near the arm, and an open end opposite the closed end, the bulb being enclosed within the lamp housing, and a lens disposed within the open end.

4. The light fixture of claim 3, wherein the lens is a collimating lens.

5. The light fixture of claim 1, further comprising a reflector at least partially surrounding the bulb.

6. The light fixture of claim 5, wherein the reflector is a diffusive reflector.

7. The light fixture of claim 5, wherein the bulb is a hot cathode tube.

8. The light fixture of claim 5, wherein the bulb is a cold cathode tube.

9. The light fixture of claim 1, wherein the ballast provides an output current of at least 20,000 Hertz.

10. The light fixture of claim 1, wherein the ballast provides an output current of at least 300 Volts.

11. A light fixture comprising:
a base;
a ballast, disposed in said base, receiving an input current from a power source, and providing an output current to the bulb;
a light cartridge including a bulb housing and a bulb at least partially disposed within the bulb housing;
a quick disconnect connector electrically connected between the ballast and the light cartridge.

12. The light fixture of claim 11, wherein the bulb includes a high intensity discharge light source.

13. The light fixture of claim 11, wherein the bulb is a hot cathode tube.

14. The light fixture of claim 11, wherein the bulb is a cold cathode tube.

15. The light fixture of claim 11, wherein the bulb housing includes a diffusive reflective surface.

16. The light fixture of claim 11, wherein the ballast provides an output current of at least 20,000 Hertz.

17. The light fixture of claim 11, wherein the ballast provides an output current of at least 300 Volts.

18. The light fixture of claim 11, further comprising:
an arm connected to the base and extending outwardly from the base; and
a lamp housing connected to an end of the arm opposite the base and receiving the light cartridge, the light cartridge being removably connected to the lamp.

19. The light fixture of claim 19, wherein the lamp housing has a closed end near the arm, and an open end opposite the closed end, the light cartridge being substantially enclosed within the lamp housing.

20. The light fixture of claim 19, further comprising a lens disposed within the open end.
